(19) United States
(12) Patent Application Publication
(10) Pub. No.: US 2002/0020161 A1
(43) Pub. Date: Feb. 21, 2002

(54) Manual fruit harvesting tool

(76) Inventor: Gilbert Simmons, Phoenix, AZ (US)

Correspondence Address: Gregory J. Nelson, NELSON & ROEDIGER, Suite 212, 3333 E. Camelback Road, Phoenix, AZ, 85018, US

(21) Appl. No.: 09/768,128

(22) Filed: Jan. 23, 2001

Related U.S. Application Data
(60) Provisional application No. 60/177,967, filed on Jan. 25, 2000.

(51) Int. Cl. A01D 46/22; A01D 46/24

(52) U.S. Cl. 56/329; 56/332; 56/339

(57) ABSTRACT

A manual fruit harvesting tool having a handle which carries a head. The head has a U-shaped member which is generally perpendicular to the handle. The U-shaped member has a long arm and a shorter arm connected by a bight. The user manipulates the head directing the fruit stem into the bight where the fruit may be severed by applying a sharp downward jerk motion to the pole.

This application is based on provisional application No. 60/177,967, filed Jan. 25, 2000, entitled “Manual Fruit Harvesting Tool.”

The present invention relates to a harvesting tool and more particularly to a manually operated tool for separating fruit, particularly citrus fruit, from the tree.

Harvesting or picking fruit such as citrus fruit, can be a difficult and laborious job. Traditionally, fruit such as citrus fruits were harvested by hand. Workers would normally access the fruit, particularly those growing at higher locations in the tree, by using a ladder. The fruit is severed by manually pulling or cutting the fruit to separate the stem from the tree branch. This procedure can be difficult because it is often hard to access much of the fruit, and once reached it can be difficult to manually remove or separate from the tree branch. This is particularly when working from a ladder and the worker attempts to reach between branches.

### BACKGROUND OF THE INVENTION

As a result, various devices have become available to assist workers removing fruit making harvesting easier. One such common harvesting device is a wire basket which is mounted on the end of the pole. Fingers extend upwardly from one edge of the basket and can be used to engage the fruit. The basket is then pulled downwardly separating the fruit from the tree causing the removed fruit to fall into the basket. However, devices of this type are somewhat difficult to manipulate through dense tree branches and often catch or snare making harvesting difficult.

A somewhat similar device is shown in U.S. Pat. No. 5,083,418 which consists of a longer pole which carries a basket in its upper end. Fruit is separated by a cutting device which is pivotally mounted on the upper end of the pole and operable by means of an operator-control line.

The prior art also discloses various picking devices which are automated and which will shake the tree causing the fruit or citrus to fall. Representative of these types of devices are the devices shown in U.S. Pat. Nos. 5,860,859, 5,765,349, 5,702,301 and 5,653,097.

While these devices may be effective, they are not suited for use by an individual or grower who has only a few trees in which to pick fruit. Further, shaking a tree can impart damage to the tree and the tree root structure.

### BRIEF SUMMARY OF THE INVENTION

Briefly, the present invention relates to a manual harvesting tool which can easily be manipulated through the tree foliage to engage the stems of fruit such as grapefruit. Once the stem is engaged, the user can apply a separating force by jerking or pulling the device downwardly.

The device consists of an elongated pole-like handle which at its upper end has a head. The head is formed as an integral member from a rod or bar stock and is secured to the upper end of the pole by any conventional method such as by crimping or insertion into a plug or rotary collar at the upper end of the pole. In a preferred embodiment, the head has a first axially extending section, a second offset section which extends angularly with respect to the axial section. The upper end is generally in the form of an open-ended “U” lying in a plane which is generally perpendicular to the axial section and handle. An angular guide section extends outwardly from one arm of the “U” to connect with the axial or offset sections.

### BRIEF DESCRIPTION OF THE DRAWINGS

The invention will be better understood from the following description and drawings in which:

FIG. 1 is a perspective use showing the fruit picker as a present invention is use;

FIG. 2 is a side view of the head and handle;

FIG. 3 is a detail view of the foot;

FIG. 4 is a cross-sectional view taken along line 4-4 of FIG. 2;

FIG. 5 is a top view of the head;

FIG. 6 is a perspective view of a basket that may be attached to the device to catch severed fruit;

FIG. 7 is a perspective view of an alternate embodiment of the head; and

FIG. 8 is a perspective view of a bag which may be attached to the tool.

### SUMMARY OF THE INVENTION

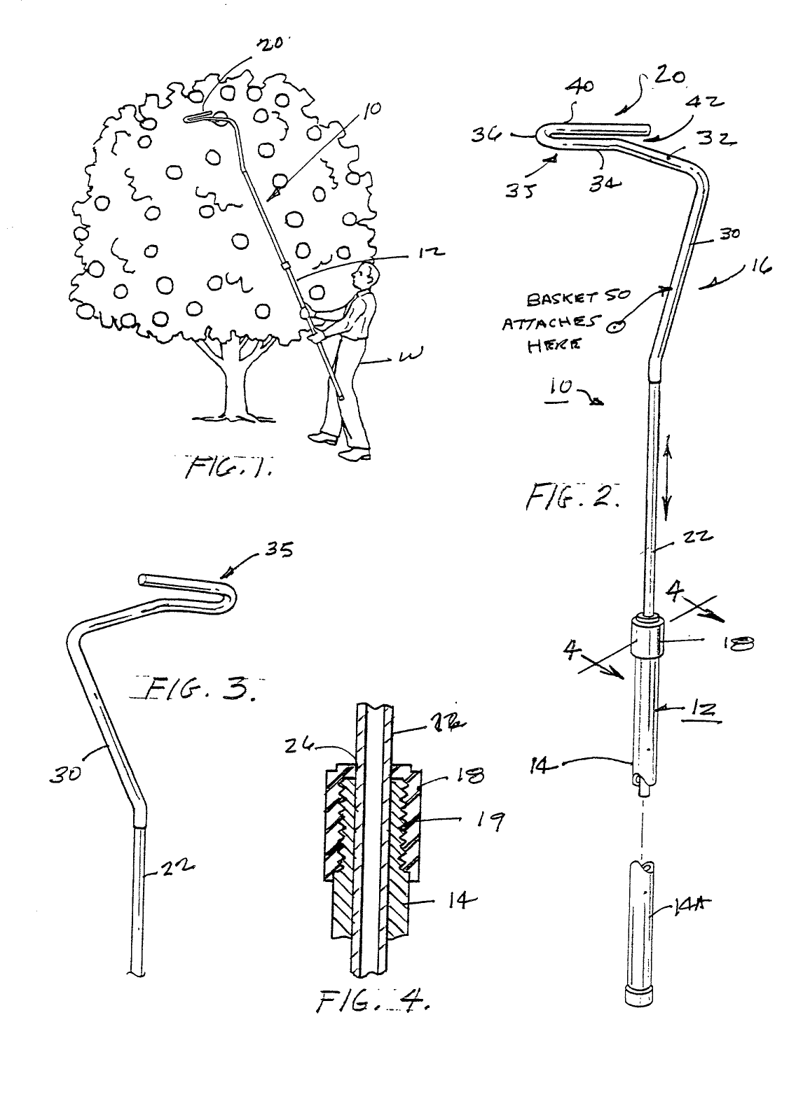

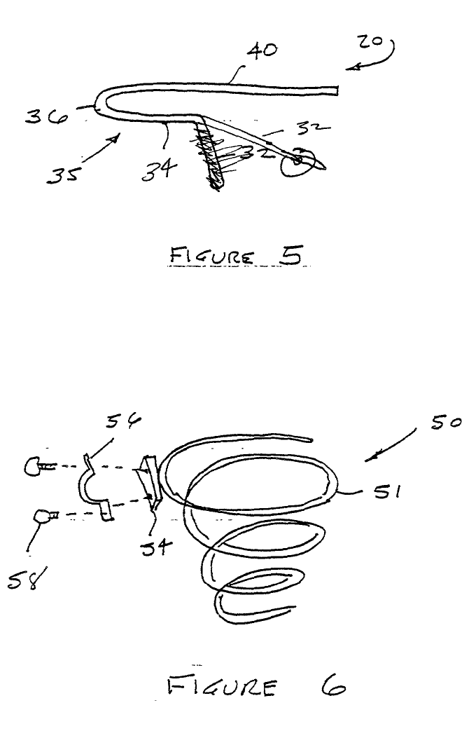

Turning now to FIGS. 1 to 6A, the fruit harvesting tool of the present invention, is generally designated by the numeral 10. The tool 10 has a long pole-type handle 12 which may be any convenient length typically 4 to 6 feet. The pole may be of any suitable material such as wood, aluminum or fiber glass and is preferably a non-conductive material. The pole may be an extendable or telescopic type pole of the type commonly used for such devices as swimming pool skimmers and brushes. If extendable, the pole has an upper section 14 and lower section 14A. the upper section 14 is telescopically received within the lower section 14A and the overall length of the pole can be adjusted and secured by rotative locking collar, which is in threaded engagement with the lower section as is conventional.

The head 20 has an axial section 22 received in the upper end of pole section 14. The head 20 is formed as a one piece or integral member from a suitable material such as round or square bar stock typically having a width or thickness of approximately one-quarter or three-eighths inch. The head can be formed by convention metal-working techniques on a brake or a press. The lower end of axial section 22 is received in a collar 18 at the upper end of the pole. The collar is shown having an axially extending bore 26 which tightly or snugly receives the axial section. The collar allows adjustment of the position of the head 20 relative to the pole.

Alternatively, the upper end of the pole 14 can also carry a plug with a pin which may be inserted through the end of the pole and into the plug into engagement with the end of the axial section 22 to prevent rotation of the head when in use. The alternate arrangement described above does not allow adjustment of the head 20 relative to the pole.

The lower axial section 22 is approximately 12 to 14 inches long and is formed having an angular offset section 30. Offset section 30 has an overall length of about six to eight inches and forms an angle of approximately 120° to 160° with respect to thee lower axial section 22.

The upper end of the offset section 30 is bent at approximately 90° and forms a section 32. Section 32 terminates at a U-shaped section 35 having a short leg 34, a bight section 36 and a longer arm or section 40. Arm 40 is approximately 6 to 8 inches long and has a gap or opening 42 defined by the arms 34 and 40 approximately one to two inches in width. The plane of the “U” section 35 is generally formed at 90° with respect to the axial section 22 and the handle. As seen in figure F, section 32 diverges from arm 40 to guide the stem of the fruit toward the bight section 40.

The extended length of arm 40 also assists in picking as it allows the tool head 20 to be easily positioned about the stem of the fruit and then the head is laterally advanced so that the stem is positioned near thee bight section 38.

FIG. 1 shows the tool of the present invention in use. The worker W is shown holding the pole 12 having guided the tool head to a position immediately adjacent the citrus fruit to be picked, in this case grapefruit. The shape and the relative small size of the tool head minimizes the possibility of entanglement with the tree foliage. The tool head is positioned so that the stem is engaged by arm 40 with the “U” shaped portion above the fruit. The head can then be manipulated by the handle to move the tool head 20 so that the stem is enclosed within the arms 34 and 40 at bight section 36. The offset 30 provides clearance to allow the worker to maneuver the tool into position around the fruit and tree branches. Once the stem is engaged, the worker can apply a quick downward motion or jerk on the handle 14. This will bring the “U” shaped bight portion 36 of the head into contact with the fruit causing either the fruit or the fruit and stem to be severed from the tree. The fruit is then free to fall to the ground or into a suitable catcher that may have been placed around the base of the tree. The shape of the head provides for easy manipulation of the device through the tree and the foliage. Further, the device is relatively compact and lightweight making it convenient to use.

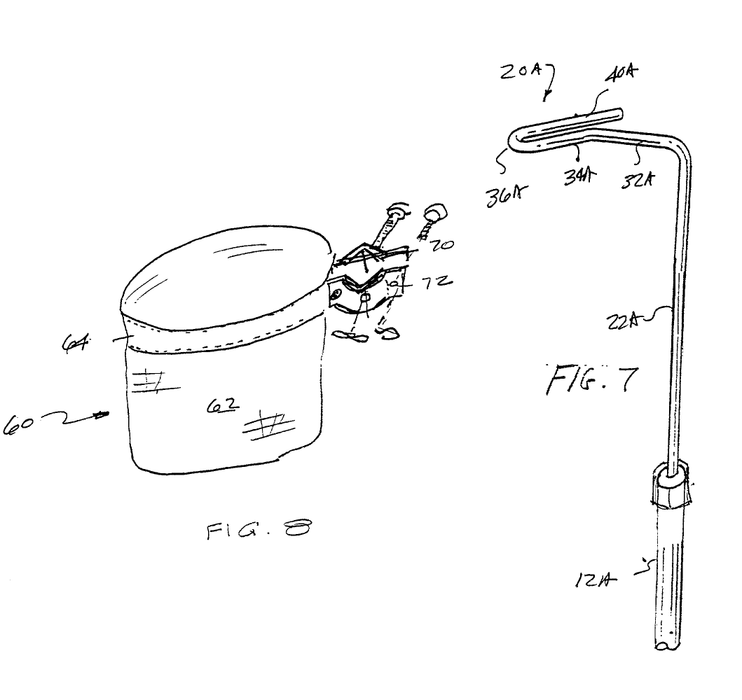

FIG. 6 shows a coiled basket 50 which is integrally formed from wire in a spiral arrangement in which the spirals 51 are of downwardly decreasing size. Plate 54 is affixed to the largest spiral at the upper end of the basket. The plate 54 is tapped and a clamp 56 is formed to engage the section 30 of the tool below the head as indicated in FIG. 2. The clamp 56 is secured by wing nuts 58. Once the basket is secured, severed fruit can be caught and collected in the basket. Since the basket is formed of wire, it is durable. The basket may easily be removed if the user elects.

FIG. 8 shows an alternate catcher basket 60 having a cloth bag 62 with a peripheral sleeve 64 which receives a clamping band 66. The clamping band 66 extends from the sleeve at plates 70 and 72 which are secured to the head along axial section 22 at a selected location so as to catch severed fruit.

FIG. 7 shows another embodiment having a handle 12A which is shown as wood which receives the head 20A. The head 20A has a U-shaped section having arms 34A, 40A connected across bight 36A. Section 32A connects arm 34A to axial section 22A which is received in the handle. The main difference between the embodiment of FIG. 2 and FIG. 7 is the eliminating of the offset 30.

The harvesting tool of the present invention is intended primarily for use by the home owner or individual who has a limited number of trees. Such an individual will normally find it necessary to pick fruit in relatively small quantities as needed. However, the tool can also be used by commercial growers and pickers because of its simplicity and ease of use. The design also renders the device relatively inexpensive to manufacture as readily available components can be used and conventional forming and assembly techniques can also be used.

It will be obvious to those skilled in the art to make various changes, modifications and alterations to the fruit picking device disclosed herein. To the extent that these various changes, alterations or modifications do not depart from the spirit and scope of the invention, they are intended to be encompassed herein.

I claim:

1. A manual fruit harvesting tool comprising:
(a) a head having an axial section having an upper and lower end;
(b) a generally U-shaped member having a long arm, a short arm and interconnected at a bight section to form a fruit stem receiving area, said U-shaped member being generally perpendicular to said axial section;
(c) a handle attached to an axial section, said axial section connected to said short arm of said U-shaped member by a guide section which diverges from said shorter arm.

4. The tool of claim 1 wherein said axial section includes an offset section.

5. The tool of claim 1 wherein said axial section and U-shaped member are integrally formed from tubular steel.

6. The tool of claim 1 wherein said handle is telescopically adjustable.

7. The tool of claim 1 further including a fruit catching means attachable to said tool below said head.

8. The tool of claim 5 wherein said fruit catching means comprises a basket having clamp means associated therewith.
